(19) United States
(12) Patent Application Publication
(10) Pub. No.: US 2008/0242795 A1
(43) Pub. Date: Oct. 2, 2008

(54) Flameproof Copolymer and Flame Retardant Thermoplastic Resin Composition Including the Same

(75) Inventors: Bok Nam JANG, Anyang-si (KR); In Chul JUNG, Seoul (KR); Hee Jung PARK, Suwon-si (KR); Mi Ran CHO, Seoul (KR); Jin Kyung CHO, Seoul (KR); Jin Hwan CHOI, Anyang-si (KR)

Correspondence Address: SUMMA, ALLAN & ADDITON, P.A., 11610 NORTH COMMUNITY HOUSE ROAD, SUITE 200, CHARLOTTE, NC, 28277, US

(73) Assignee: CHEIL INDUSTRIES INC., Gumi-si (KR)

(21) Appl. No.: 12/050,217

(22) Filed: Mar. 18, 2008

Related U.S. Application Data
(63) Continuation-in-part of application No. PCT/KR2007/007028, filed on Dec. 31, 2007.

(30) Foreign Application Priority Data
Mar. 30, 2007 (KR) 10-2007-0031454
May 15, 2007 (KR) 10-2007-0047273

(51) Int. Cl. C08L 43/02

(52) U.S. Cl. 524/547; 526/274

(57) ABSTRACT

Disclosed herein is a flameproof copolymer comprising repeating units of (A) about 80 to about 99% by weight of a (meth)acrylic monomer and (B) about 1 to about 20% by weight of a vinyl-containing phosphorous monomer. The present invention also provides a thermoplastic resin composition including the flameproof copolymer.

### CROSS-REFERENCE TO RELATED APPLICATIONS

This application is a continuation-in-part application of PCT Application No. PCT/KR2007/007028, filed Dec. 31, 2007, pending, which designates the U.S., and claims priority from Korean Patent Application No. 2007-47273, filed May 15, 2007, and Korean Patent Application No. 2007-31454, filed Mar. 30, 2007, the entire disclosure of each of which is incorporated herein by reference.

### FIELD OF THE INVENTION

The present invention relates to a flameproof copolymer and flame retardant thermoplastic resin composition including the same.

### BACKGROUND OF THE INVENTION

Acryl monomer resins generally have good transparency, weatherability, mechanical properties, and excellent thermal stability. Therefore, acryl monomer resins have been widely used in electronic articles, display parts, optical materials, architectural parts, and automobile parts as well as conventional molded articles. In particular, acryl resins have such good scratch resistance that the use thereof has been growing in external parts of electric or electronic goods. However, acryl resins are typically flammable, which can limit their use.

Blending an additive-type flame retardant with an acryl resin has been proposed to improve the flame retardancy of acryl resins. This method, however, requires a large amount of flame retardants in order to obtain the desired level of flame retardancy. Further, blending a flame retardant with an acryl resin can result in a poor appearance due to the dissolution of flame retardant. Furthermore, this method can reduce the properties of the acryl-based resin, such as transparency, heat resistance, and mechanical properties.

U.S. Pat. No. 4,035,571 discloses a flameproof copolymer prepared by copolymerizing unsaturated monomer, bis(hydrocarbyl)vinyl phosphonate, and acrylic acid or methacrylic acid. However, this method requires a large amount of bis(hydrocarbyl)vinyl phosphonate to obtain enough flame retardancy. This, in turn, can result in poor mechanical properties and also limits the uses of the copolymer.

### SUMMARY OF THE INVENTION

The present inventors have developed a flameproof copolymer and flame retardant thermoplastic resin composition including the same having good flame retardancy, transparency, and scratch resistance while maintaining mechanical properties. The thermoplastic resin composition can be environmentally friendly because it does not generate toxic gases such as dioxin, furan, or halogenated hydrogen gas at the time of combustion. In addition, the thermoplastic resin composition can have a good balance of physical properties.

One aspect of the invention provides a flameproof copolymer which comprises repeating units of (a) about 80 to about 99% by weight of a (meth)acrylic monomer and (b) about 1 to about 20% by weight of a vinyl-containing phosphorous monomer. In an exemplary embodiment of the invention, the vinyl-containing phosphorous monomer (b) may contain about 18 to about 30% by weight of phosphorus.

Another aspect of the present invention relates to a method for preparing a flameproof copolymer. The method comprises copolymerizing a (meth)acrylic monomer and a vinyl-containing phosphorous monomer at a temperature of about 60 to about 90° C. for about 1 to about 6 hours in the presence of a radical initiator.

The present invention further provides a flame retardant thermoplastic resin composition containing the foregoing flameproof copolymer. The resin composition may have a haze of about 2% or less as measured by a Nippon Denshoku Haze meter using a 3 mm thick test sample, a pencil hardness of about 2H measured in accordance with JIS K 5401, an Izod impact strength of about 1.3 kgf·cm/cm or more measured in accordance with ASTM D-256 using a ⅛″ thick test sample, heat resistance (Vicat Softening Temperature or “VST”) of about 97° C. or more measured in accordance with ASTM D-1525 using a ¼″ thick test sample, and a flame retardancy of V-2, V-1 or V-0 measured in accordance with UL 94 using a 2.0 mm thick test sample.

The resin composition of the invention may further include an additive selected from the group consisting of impact modifiers, anti-dripping agents, phenol resins, flame retardants, flame retardant aids, lubricants, antioxidants, plasticizers, thermal stabilizers, light stabilizers, pigments, dyes, inorganic fillers, and the like, and mixtures thereof.

In an exemplary embodiment of the invention, the resin composition may include the impact modifier in an amount of about 30 parts by weight or less, per 100 parts by weight of the flameproof copolymer. A rubber modified graft copolymer may be used as the impact modifier.

In an exemplary embodiment of the invention, the resin composition may include the anti-dripping agent in an amount of about 2 parts by weight or less, per 100 parts by weight of flameproof copolymer.

In other exemplary embodiments, the resin composition may include the phenol resin in an amount of about 1 to about 20 parts by weight, per 100 parts by weight of flameproof copolymer.

In other embodiment, the resin composition may have a haze of about 17% or less measured by a Nippon Denshoku Haze meter using a 3 mm thick test sample, a pencil hardness of about 2H or more measured in accordance with JIS K 5401, an Izod impact strength of about 1.3 kgf·cm/cm or more measured in accordance with ASTM D-256 using a ⅛″ thick test sample, heat resistance (VST) of about 95° C. or more measured in accordance with ASTM D-1525 using a ¼″ thick test sample, and a flame retardancy of V-2, V-1 or V-0 measured in accordance with UL 94 using a 2.0 mm thick test sample.

Further, the present invention provides a molded article of the resin composition.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The flameproof copolymer according to the invention comprises repeating units of (a) (meth)acrylic monomer and (b) vinyl-containing phosphorous monomer.

Examples of the (meth)acrylic monomer (a) may include but are not limited to acrylate, alkyl acrylate, (meth)acrylate, alkyl(meth)acrylate, and (meth)acrylic acid. The (meth)acrylic monomer can be used alone or in combination with one another. Exemplary (meth)acrylic monomers can include without limitation (meth)acrylate, methyl(meth)acrylate, ethyl(meth)acrylate, propyl(meth)acrylate, butyl(meth)acrylate, pentyl(meth)acrylate, cyclohexyl(meth)acrylate, n-hexyl(meth)acrylate, glycidyl(meth)acrylate, (meth)acrylic acid, and the like, and mixtures of thereof.

The vinyl-containing phosphorous monomer (b) can be one or more selected from the compounds represented by chemical formulae 1 to 4.

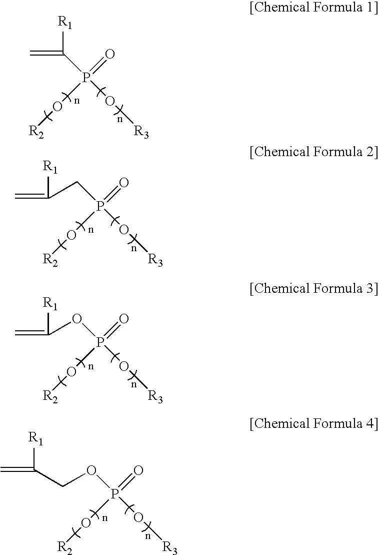

In the above chemical formulae 1 to 4, R₁ is hydrogen or methyl, R₂ and R₃ are independently methyl or ethyl, and n is 0 or 1.

Examples of the compound represented by chemical formula 1 may include without limitation dimethylvinylphosphineoxide, ethylmethylvinylphosphineoxide, diethylvinylphosphineoxide, dimethyl 2-methylvinylphosphineoxide, ethylmethyl 2-methylvinylphosphineoxide, diethyl 2-methylvinylphosphineoxide, dimethylvinylphosphinate, ethylmethylvinylphosphinate, diethylvinylphosphinate, dimethyl 2-methylvinylphosphinate, ethylmethyl 2-methylvinylphosphinate, diethyl 2-methylvinylphosphinate, dimethylvinylphosphonate, ethylmethylvinylphosphonate, diethylvinylphosphonate, dimethyl 2-methylvinylphosphonate, ethylmethyl 2-methylvinylphosphonate, diethyl 2-methylvinylphosphonate, and the like, and mixtures thereof.

Examples of the compound represented by chemical formula 2 may include without limitation allyldimethylphosphineoxide, allylmethylethylphosphineoxide, allyldiethylphosphineoxide, 2-methylallyldimethylphosphineoxide, 2-methylallylmethylethylphosphineoxide, 2-methylallyldiethylphosphineoxide, allyldimethylphosphinate, allylmethylethylphosphinate, allyldiethylphosphinate, 2-methylanyldimethylphosphinate, 2-methylallylmethylethylphosphinate, 2-methylallyldiethylphosphinate, allyldimethylphosphonate, allylmethylethylphosphonate, allyldiethylphosphonate, 2-methylallyldimethylphosphonate, 2-methylallylmethylethylphosphonate, 2-methylallyldiethylphosphonate, and the like, and mixtures thereof.

Examples of the compound represented by chemical formula 3 may include without limitation vinyldimethylphosphinate, vinylethylmethylphosphinate, vinyldiethylphosphinate, 2-methylvinyldimethylphosphinate, 2-methylvinylmethylethylphosphinate, 2-methylvinyldiethylphosphinate, vinyldimethylphosphonate, vinylethylmethylphosphonate, vinyldiethylphosphonate, 2-methylvinyldimethylphosphonate, 2-methylvinylethylmethylphosphonate, 2-methylvinyldiethylphosphonate, dimethylvinylphosphate, ethylmethylvinylphosphate, diethylvinylphosphate, dimethyl 2-methylvinylphosphate, ethylmethyl 2-methylvinylphosphate, diethyl 2-methylvinylphosphate, and the like, and mixtures thereof.

Examples of the compound represented by chemical formula 4 may include without limitation allyldimethylphosphinate, allylethylmethylphosphinate, allyldiethylphosphinate, 2-methylallyldimethylphosphinate, 2-methylallylmethylethylphosphinate, 2-methylallyldiethylphosphinate, allyldimethylphosphonate, allylethylmethylphosphonate, allyldiethylphosphonate, 2-methylallyldimethylphosphonate, 2-methylallylethylmethylphosphonate, 2-methylallyldiethylphosphonate, allyldimethylphosphate, allylethylmethylphosphate, allyldiethylphosphate, 2-methylallyldimethylphosphate, 2-methylallylethylmethylphosphate, 2-methylallyldiethylphosphate, and the like, and mixtures thereof.

The vinyl-containing phosphorous monomer (b) may include about 18 to about 30% by weight of phosphorus in the structure thereof, for example about 20 to about 29% by weight of phosphorus. If the vinyl phosphorous compound contains less than about 18% by weight of phosphorus, the copolymer may not have sufficient flame retardancy. A vinyl phosphorous compound containing more than about 30% by weight of phosphorus, however, can lower compatibility.

In an embodiment of the present invention, the copolymer may comprise repeating units of about 80 to about 90% by weight of a (meth)acrylic monomer and about 5 to about 20% by weight of a vinyl-containing phosphorous monomer to provide high flame retardancy and good mechanical properties. In other exemplary embodiments, the copolymer may include about 85 to about 95% by weight of a (meth)acrylic monomer and about 5 to about 15% by weight of a vinyl-containing phosphorous monomer.

An exemplary method for preparing the vinyl-containing phosphorous monomer (c) is disclosed in Japanese Patent No. 3836459, the teachings of which are incorporated herein by reference in their entirety.

The flameproof copolymer of the present invention can be prepared by a conventional copolymerization in which the vinyl-containing phosphorous monomer is added to the (meth)acrylic monomer in the presence of a radical initiator. Since the vinyl-containing phosphorous monomer has a polymerizable vinyl group, the vinyl-containing phosphorous monomer and the (meth)acrylic monomer can together form a main chain. An unsaturated group containing monomer, for example, an aromatic vinyl monomer, can be optionally added while copolymerizing. The amount of the (meth)acrylic monomer and the vinyl-containing phosphorous monomer may be controlled by adding the monomer(s) until the repeating unit of the final copolymer reaches the ratio level discussed above.

In an embodiment of the present invention, a (meth)acrylic monomer and a vinyl-containing phosphorous monomer may be added to a reactor, followed by copolymerizing at about 60 to about 90° C. for about 1 to about 6 hours in the presence of an initiator.

Suitable initiators may include, but are not limited to, radical initiators such as benzoyl peroxide (BPO), dicumylperoxide (DCP), di-tert-butylperoxide (DTBP), azobisisobutyronitrile (AIBN), and the like, and mixtures thereof.

The flameproof copolymer of the present invention can be used in place of a conventional acrylic resin. For example, the flameproof copolymer may be used alone, or used in a thermoplastic resin composition by blending with other resins or additives to improve impact strength and flame retardancy.

Impact modifier

The flame retardant thermoplastic resin composition of the present invention may further comprise an impact modifier as needed. The impact modifier may be a polymer prepared by grafting a rubber polymer with a vinyl monomer. The impact modifier may be prepared by graft copolymerizing an aromatic vinyl monomer and optionally a copolymerizable monomer onto a rubber polymer.

Examples of the rubber polymer can include without limitation at least one rubber polymer selected from the group consisting of diene-based rubbers such as polybutadiene rubber, poly(styrene-butadiene) rubber, and poly(acrylonitrile-butadiene) rubber, saturated rubbers in which hydrogen is added to a diene rubber, isoprene rubbers, acrylic rubbers, silicon rubbers, ethylene/propylene rubbers, and ethylene-propylene-diene terpolymer (EPDM). The impact modifier can include rubber in an amount of about 5 to about 65% by weight, based on the total weight of the graft copolymer resin. The rubber polymer may have an average particle size of about 0.1 to about 4 μm, depending on the impact strength and the appearance of a molded article. The impact modifier may be used in an amount of about 30 parts by weight or less, based on 100 parts by weight of the flameproof copolymer, for example, about 0.1 to about 20 parts by weight, and as another example about 0.5 to about 15 parts by weight. If the amount of the impact modifier is more than about 30 parts by weight, the flame retardancy can be lowered.

### Anti-Dripping Agent

The flame retardant thermoplastic resin composition of the present invention can further include an anti-dripping agent according as needed. The anti-dripping agent may be an additive which can exist in the form of fiber in the resin phase, after a mixing process with the resin. Examples thereof can include without limitation a fluoro-based resin, for example, polytetrafluoroethylene, a copolymer of tetrafluoroethylene and hexafluoropropylene, a fluorinated carbon resin of tetrafluoroethylene and perfluoroalkylvinylether, and polyvinylidenefluoride, and the like, and mixtures thereof.

The resin composition can include the anti-dripping agent in an amount of about 2 parts by weight or less per 100 parts by weight of the flameproof copolymer. When the anti-dripping agent is used in an amount greater than about 2 parts by weight, the impact resistance may be deteriorated.

### Phenol Resin

The resin composition of the present invention may further include a phenol resin as a char forming agent. Since the phenol resin can form a char at low temperature (about 300 to about 450° C.), it may play an effective role in forming char on the surface in early combustion.

Phenol resins are generally classified into resol-type phenolic resins and novolak-type phenolic resins. In the present invention, the novolak-type phenolic may be particularly useful. The novolak-type phenolic resins may include without limitation phenol formaldehyde novolak resin, tertiarybutylphenol formaldehyde novolak resin, para octylphenol formaldehyde novolak resin, para cyanophenol formaldehyde novolak resin, phenolepoxy novolak resin, and the like, and mixtures thereof. The novolak-type phenolic resin can have a weight average molecular weight (Mw) of about 300 to about 10,000.

The resin composition can include the phenol resin in an amount of about 1 to about 20 parts by weight per 100 parts by weight of the flameproof copolymer, for example about 1 to about 10 parts by weight. If the amount of the phenol resin is more than about 20 parts by weight, the mechanical properties may be degraded, and weatherability may be lowered.

The resin composition of the invention may further include an additive selected from the group consisting of flame retardants, flame retardant aids, lubricants, antioxidants, plasticizers, thermal stabilizers, light stabilizers, inorganic fillers, pigments, dyes, and the like. These additives can be used alone or in combination with one another.

The flame retardant can be a phosphorous flame retardant or a halogen flame retardant. Examples of the phosphorous flame retardant may include without limitation red phosphorus, phosphate, phosphonate, phosphinate, phosphine oxide, phosphazene, a metal salt thereof, and the like, and mixtures thereof, such as an aromatic phosphoric acid ester (phosphate) compound.

The resin composition can include the flame retardant in an amount of about 30 parts by weight or less per 100 parts by weight of the flameproof copolymer, for example about 0.1 to about 15 parts, and as another example about 0.3 to about 10 parts by weight. If the amount of the flame retardant is more than about 30 parts by weight, mechanical properties such as flame retardancy and impact strength may be degraded.

The resin composition according to the present invention can be prepared by a conventional process. For example, all the components and additives can be mixed together and extruded through an extruder and can be prepared in the form of pellets.

Further, the resin composition according to the present invention may be used in various molded products. In particular, the resin composition is suitable for the production of electric and electronic goods such as housings of TV, computers, audio sets, air conditioners, office automation devices, and the like.

The invention may be better understood by reference to the following examples which are intended for the purpose of illustration and are not to be construed as in any way limiting the scope of the present invention, which is defined in the claims appended hereto.

### EXAMPLES

### Example 1

90 parts by weight of methylmethacrylate, 10 parts by weight of dimethylvinylphosphonate containing 22.76% by weight of phosphorus, and 0.3 parts by weight of benzoyl peroxide are added into a reactor and stirred to react at 80° C. for 3 hours. The resulting polymer is dried in a vacuum oven to obtain a flame retardant PMMA copolymer (VP-PMMA). Then, the VP-PMMA copolymer is extruded through a twin screw extruder into pellets at 200 to 260° C. The pellets are molded into test specimens using a 8 oz injection molding machine at 250° C. with a barrel temperature of 60° C.

### Example 2

Example 2 is prepared in the same manner as in Example 1 except that 5 parts by weight of EXL-2602 (methyl methacrylate-butadiene-acrylate copolymer) manufactured by MRC Co. is further added as an impact modifier.

### Example 3

Example 3 is prepared in the same manner as in Example 2 except that 0.5 parts by weight of polytetrafluoroethylene (Teflon 30J manufactured by Mitsui-Dupont Company) is further added as an anti-dripping agent.

### Example 4

Example 4 is prepared in the same manner as in Example 1 except that 0.5 parts by weight of polytetrafluoroethylene (Teflon 30J manufactured by Mitsui-Dupont Company) is further added as an anti-dripping agent.

### Comparative Example 1

Comparative Example 1 is prepared in the same manner as in Example 1 except that 75 parts by weight of a conventional PMMA copolymer (L-84 manufactured by LG Chem. Co. of Korea) not containing dimethylvinylphosphonate is used instead of the flame retardant PMMA copolymer of the present invention, and that 25 parts by weight of resorcinol bis(2,6dimethylphenylphosphate) (PX-200 manufactured by Daihachi Chemical Co. of Japan) is added as a flame retardant.

### Comparative Example 2

Comparative Example 2 is prepared in the same manner as in Comparative Example 1 except that 5 parts by weight of EXL-2602 (methyl methacrylate-butadiene-acrylate copolymer) manufactured by MRC Co. is further added as an impact modifier.

### Comparative Example 3

Comparative Example 3 is prepared in the same manner as in Comparative Example 2 except that 0.5 parts by weight of polytetrafluoroethylene (Teflon 30J manufactured by Mitsui-Dupont Company) is further added as an anti-dripping agent.

### Comparative Example 4

Comparative Example 4 is prepared in the same manner as in Comparative Example 1 except that 0.5 parts by weight of polytetrafluoroethylene (Teflon 30J by Mitsui-Dupont) is further added as an anti-dripping agent.

The physical properties of the test specimens produced in the Examples and Comparative Examples are measured as follows and the test results are shown in Table 1 below.

(1) Haze (%): Haze (%) is measured by a Nippon Denshoku Haze meter using a 3 mm thick test sample.

(2) Pencil Hardness: The pencil hardness is measured for 10×10 cm² specimens after exposure at 23° C. and 50% of relative humidity for 48 hours in accordance with JIS K 5401. The scratch resistance is measured by 3B, 2B, B, HB, F, H, 2H, 3H, etc. The higher the H value, the better the scratch resistance is. The higher the B value, the lower the scratch resistance is.

(3) Izod Impact Strength: The notch Izod impact strength is measured in accordance with ASTM D-256 (⅛ inch, kgf·cm/cm).

(4) Heat Resistance (VST): The Vicat Softening Temperature is measured in accordance with ASTM D-1525 (¼″ inch, kgf·cm/cm) under 5 kgf load (° C.).

(5) Flame Retardancy: The flame retardancy is measured in accordance with UL 94 using a 2.0 mm thick test sample.

TABLE 1

| | | Examples | | | | comparative examples | | | |
|---|---|---|---|---|---|---|---|---|---|
| | | 1 | 2 | 3 | 4 | 1 | 2 | 3 | 4 |
| contents | VP-PMMA | 100 | 100 | 100 | 100 | — | — | — | — |
| (parts by | PMMA | — | — | — | — | 75 | 75 | 75 | 75 |
| weight) | impact modifier | — | 5 | 5 | — | — | 5 | 5 | — |
| | PX-200 | — | — | — | — | 25 | 25 | 25 | 25 |
| | PTFE | — | — | 0.5 | 0.5 | — | — | 0.5 | 0.5 |
| physical | Haze | 1.5 | 15.5 | 16.8 | 3.9 | 6.9 | 33.3 | 35.7 | 8.2 |
| properties | pencil hardness | 3H | 2H | 2H | 3H | 2H | H | H | 2H |
| | Izod impact | 1.4 | 4.5 | 4.7 | 1.6 | 1.1 | 3.3 | 3.8 | 1.3 |
| | strength | | | | | | | | |
| | VST(° C.) | 97.3 | 96.5 | 96.9 | 97.1 | 78.2 | 77.5 | 78.9 | 78.1 |
| | UL 94 | V2 | V2 | V1 | V0 | V2 | Fail | burning | burning |

* Fail: failure to obtain UL flame retardant grade,
* Burning: test specimens all burned out.

As shown in Table 1, Example 1 shows good transparency, pencil hardness, and heat resistance due to low haze. Example 2 shows low but sufficient transparency as it contains an impact modifier, and shows a good balance of physical properties such as impact strength and flame resistance. Examples 3-4 employing PTFE as an anti-dripping agent show little change of physical properties, and show upgrading of flameproof to V1 and V0 compared to Examples 1-2. On the other hand, Comparative Examples 1-4 using conventional PMMA show low flame retardancy and low flame resistance even though they contain the same amount of phosphorus as Examples 1-4. Comparative Examples 1-4 also show that flame resistance is dramatically lowered.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims. What is claimed is:

1. A flameproof copolymer comprising repeating units of:
(A) about 80 to about 99% by weight of a (meth)acrylic monomer; and
(B) about 1 to about 20% by weight of a vinyl-containing phosphorous monomer.

2. The flameproof copolymer of claim 1, wherein said vinyl-containing phosphorous monomer (B) comprises at least one monomer selected from the compounds represented by chemical formulae 1 to 4: 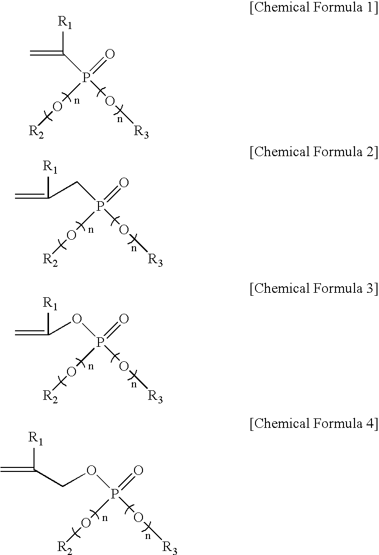
wherein R₁ is hydrogen or methyl, R₂ and R₃ are independently methyl or ethyl, and n is 0 or 1.

3. The flameproof copolymer of claim 1, wherein said vinyl-containing phosphorous monomer (B) comprises about 18 to about 30% by weight of phosphorus.

4. The flameproof copolymer of claim 1, wherein said (meth)acrylic monomer (A) is selected from the group consisting of (meth)acrylate, methyl(meth)acrylate, ethyl(meth)acrylate, propyl(meth)acrylate, butyl(meth)acrylate, pentyl(meth)acrylate, cyclohexyl(meth)acrylate, n-hexyl(meth)acrylate, glycidyl(meth)acrylate, (meth)acrylic acid and mixtures thereof.

5. A flame retardant thermoplastic resin composition comprising a flameproof copolymer comprising repeating units of (A) about 80 to about 99% by weight of a (meth)acrylic monomer; and (B) about 1 to about 20% by weight of a vinyl-containing phosphorous monomer.

6. The flame retardant thermoplastic resin composition of claim 5, wherein said resin composition has a haze of about 2% or less as measured by a Nippon Denshoku Haze meter using a 3 mm thick test sample, a pencil hardness of about 2H measured in accordance with JIS K 5401, an Izod impact strength of about 1.3 kgf·cm/cm or more measured in accordance with ASTM D-256 using a ⅛″ thick test sample, heat resistance (VST) of about 97° C. or more measured in accordance with ASTM D-1525 using a ¼″ thick test sample, and a flame retardancy of V-2, V-1 or V-0 measured in accordance with UL 94 using a 2.0 mm thick test sample.

7. A molded article produced from the flame retardant thermoplastic resin composition as defined in claim 5.

8. The flame retardant thermoplastic resin composition of claim 5, further comprising at least one additive selected from the group consisting of impact modifiers, anti-dripping agents, phenol resins, flame retardants, flame retardant aids, lubricants, antioxidants, plasticizers, thermal stabilizers, light stabilizers, pigments, dyes, inorganic fillers and mixtures thereof.

9. The flame retardant thermoplastic resin composition of claim 8, wherein said impact modifier is used in the range of about 30 parts by weight or less, per 100 parts by weight of the flameproof copolymer.

10. The flame retardant thermoplastic resin composition of claim 8, comprising said anti-dripping agent in an amount of about 2 parts by weight or less, per 100 parts by weight of the flameproof copolymer.

11. The flame retardant thermoplastic resin composition of claim 8, comprising said phenol resin in an amount of about 1 to about 20 parts by weight or less, per 100 parts by weight of the flameproof copolymer.

12. The flame retardant thermoplastic resin composition of claim 8, wherein said resin composition has a haze of about 17% or less measured by a Nippon Denshoku Haze meter using a 3 mm thick test sample, a pencil hardness of about 2H or more measured in accordance with JIS K 5401, an Izod impact strength of about 1.3 kgf·cm/cm or more measured in accordance with ASTM D-256 using a ⅛″ thick test sample, heat resistance (VST) of about 95° C. or more measured in accordance with ASTM D-1525 using a ¼″ thick test sample, and a flame retardancy of V-2, V-1 or V-0 measured in accordance with UL 94 using a 2.0 mm thick test sample.

13. A molded article produced from the flame retardant thermoplastic resin composition as defined in claim 8.

14. A method for preparing a flameproof copolymer comprising: copolymerizing a (meth)acrylic monomer and a vinyl-containing phosphorous monomer at a temperature of about 60 to about 90° C. for about 1 to about 6 hours in the presence of a radical initiator.
